(19) United States
(12) Patent Application Publication
(10) Pub. No.: US 2002/0160149 A1
(43) Pub. Date: Oct. 31, 2002

(54) Bottle holder stiff-back for diving activities with integrated padding

(76) Inventor: Giovanni Garofalo, Rapallo (IT)

Correspondence Address: LARSON & TAYLOR, PLC, 1199 NORTH FAIRFAX STREET, SUITE 900, ALEXANDRIA, VA, 22314, US

(21) Appl. No.: 10/132,452

(22) Filed: Apr. 26, 2002

(30) Foreign Application Priority Data
Apr. 27, 2001 (IT) GE2001 U 000013

(51) Int. Cl. B32B 3/10

(52) U.S. Cl. 428/139

(57) ABSTRACT

Bottle-holder stiff back for diving activities, comprising a shell in plastic material, characterized in that pads and/or inserts of expanded or soft padding material are applied on the side of said shell turned towards the user's back.

### BACKGROUND AND SUMMARY OF THE INVENTION

The present invention relates to bottle-holder stiff backs for diving activities. Said backs are usually equipped on the side towards the user's back with a suitable soft coating, such as a mat in expanded material or the like. The use of said mats shows several disadvantages: so, for instance, they do not enable an optimal distribution of the padding material, or they can tend to move or curl, or the like.

The present invention therefore aims at carrying out a stiff back of the above-mentioned kind, in which the padding is obtained by overprinting on the back pads and/or inserts of expanded or soft material. This allows to obtain, beyond evident economic advantages and the convenience of having a unique integrated item, also the advantage of distributing the position and/or the thickness of the pads selectively and according to the user's body parts which they should protect.

### BRIEF DESCRIPTION OF THE DRAWINGS

Further aims and advantages of the present invention will be better evident from the following description of some preferred embodiments of said invention, which is carried out with reference to the enclosed drawing, in which:

FIG. 1 is a plan view of a bottle-holder back provided with the pads according to the invention, taken from the side of the back turned towards the user's body;

FIG. 2 is an enlarged detail in longitudinal section of a first way of fastening a pad to the back, and

FIG. 3 is a view, analogous to FIG. 2, showing another way of fastening a pad to the back.

### DESCRIPTION OF THE PREFERRED EMBODIMENT OF THE INVENTION

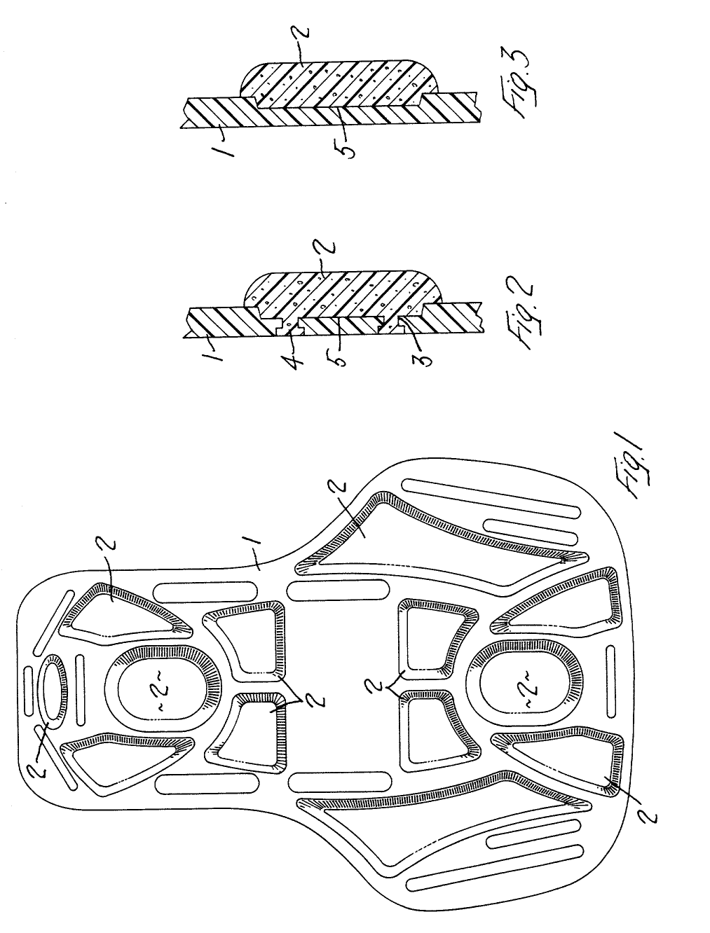

With reference to the drawing, and in particular to FIG. 1, the numeral 1 indicates a stiff back, for instance made of stiff plastic, possibly reinforced with fibers. According to the invention, a series of pads 2 in soft material, for instance expanded resin or a material analogous to foam-rubber, is applied on the surface of said back, which—when used—is turned towards the user's back. These pads 2 are advantageously applied by overprinting the plastic material they are made of onto the back 1. To such purpose the areas of the back 1 where the pads 2 should be applied are delimited, while printing said back 1, by means of hollows 5 having the same profile as the pads 2 they should house. If the plastic material the pads 2 are made of is compatible with the one of the back, the simple overprinting of the pads 2 into the hollows 5, as shown in FIG. 3, determines a strong adhesion between the two materials, so that no further fastening means are necessary. If the plastic material the pads 2 are made of shows little or no compatibility with the one of the back 1, so that the pads 2 could easily come off the back 1, the hollows 5 are provided, while printing the back 1, with through holes 3, flared or otherwise widened towards the opposite side of the back, so that while overprinting the pads 2, a part 4 of the material of said pads 2 penetrates into said holes 3 and fills them up, thus providing for a strong fastening of the pads 2 to the back 1.

The present invention is not obviously limited to the embodiments shown and described, but it comprises all those variants and changes falling within the wider framework of the new idea underlying the invention, substantially as later claimed.

1. Bottle-holder stiff back for diving activities, comprising a shell in plastic material, in which pads of expanded or soft padding material are applied on the side of said shell turned towards the user's back.

2. Bottle-holder stiff back according to claim 1, in which said pads are applied by overprinting the material they are made of onto the shell in plastic material of the back.

3. Bottle-holder stiff back according to claim 1, in which said pads are made of soft plastic material with open or closed cells, or of an elastomeric material.

4. Bottle-holder stiff back according to claim 1, in which said pads are distributed in extension and/or thickness on the surface of the back in a selective way and according to the user's body parts which they should protect.

5. Bottle-holder stiff back according to claim 1, in which the areas of the back where the pad should be applied are delimited, while printing said back, by means of hollows having the same profile as the pads which they should house.

6. Bottle-holder stiff back according to claim 5, in which said hollows are provided, while printing said back, with through holes, flared or otherwise widened towards the opposite side of the back, so that while overprinting the pads a part of the material of said pads penetrates into the holes and fills them up, thus providing for a strong fastening of the pads to the back.
